(19) United States
(12) Patent Application Publication
(10) Pub. No.: US 2018/0159387 A1
(43) Pub. Date: Jun. 7, 2018

(54) Rotating electric machine with a stator closed notches and, more particularly variable-reluctance synchronous electric machine assisted by permanent magnets

(71) Applicants: IFP Energies nouvelles, Rueil-Malmaison (FR); Mavel S.r.l., PONT SAINT MARTIN (IT)

(72) Inventors: Julien BOISSON, SCEAUX (FR); Wissam DIB, SURESNES (FR); Rinato BIGLINO, GENOA (IT); Davide BETTONI, SETTIMO VITTONE (IT)

(21) Appl. No.: 15/577,689

(22) PCT Filed: May 12, 2016
(86) PCT No.: PCT/EP2016/060697

§ 371 Date: Nov. 28, 2017

(30) Foreign Application Priority Data
May 28, 2015 (FR) 1554835

(51) Int. Cl. H02K 1/16; H02K 1/27; H02K 3/487

(52) U.S. Cl. CPC H02K 1/165; H02K 3/487; H02K 1/274

(57) ABSTRACT

The present invention relates to an electric machine comprising a rotor (10) and a stator (12) comprising a wall (32) facing the rotor. The including radial slots disposed circumferentially around the stator. The slots (36) comprise a bottom wall (38) separated from the wall of the stator to close the slots.

### CROSS REFERENCE TO RELATED APPLICATIONS

Reference is made to International Application No. PCT/EP2016/060697 filed May 12, 2016, and French Application No. 15/54.835 filed May 28, 2015, which are incorporated herein by reference in their entirety.

### BACKGROUND OF THE INVENTION

### Field of the Invention

The present invention relates to a rotary electric machine with a closed-slotted stator and, more specifically, to a permanent magnet assisted synchronous variable reluctance electric machine.

### Description of the Prior Art

In general, an electric machine with permanent magnet assisted synchronous variable reluctance comprises a stator and a rotor which are arranged coaxially one inside the other.

The rotor is formed of a rotor body with a stack of laminations placed on a rotor shaft. These laminations comprise housings for permanent magnets and perforations that create flux barriers so that the magnetic flux can be directed radially from the magnets towards the stator.

This rotor is generally held inside a stator which bears electric windings making it possible to generate a magnetic field for driving the rotation of the rotor.

As better described in document EP 1 057 242, the stator is annular in shape and comprises a plurality of radial slots open towards the rotor and extending all along the periphery of the stator.

These slots are designed to accept armature windings which are introduced into the stator by the open face of the slots and then fixed thereto by any known mechanism.

In general, the ripple on the torque is great in this type of permanent magnet assisted synchronous reluctance machine.

This may generate jerkiness and vibration at the rotor, leading to discomfort in the use of this machine.

### SUMMARY OF THE INVENTION

The present invention seeks to overcome the disadvantages listed hereinabove with an electric machine having a stator with closed slots for reducing the ripple of the torque and the accompanying acoustic noise.

To this end, the present invention relates to an electric machine comprising a rotor and a stator comprising a wall facing the rotor, the stator bearing a multitude of radial slots arranged circumferentially along the stator, characterized in that the slots comprise a bottom wall located at a distance from the wall of the stator so as to form a multitude of closed slots.

The slots may extend axially along the stator.

The slots may have an oblong cross section with a bottom wall located at a distance from the wall of the stator, a top wall and two faces connecting the walls.

The slots may have a circular cross section.

The rotor may comprise housings for magnetic-flux generators and recesses forming flux barriers.

### BRIEF DESCRIPTION OF THE DRAWINGS

The other features and advantages of the invention will now become apparent from reading the description which will follow, which is given solely by way of nonlimiting illustrative example and to which are appended:

FIG. 1 is a schematic view in cross section of the electric machine according to the invention;

FIG. 2 is a schematic view in cross section of the stator of the machine of FIG. 1 with a local section on the closed line A;

FIG. 3 is a graph illustrating how torque evolves at constant current as a function of the electrical position of the rotor for an electric machine of the prior art and for an electric machine according to the invention, and

FIG. 4 is a graph with curves illustrating the instantaneous torque of the electric machine (in N·m) with respect to the electric position of the machine.

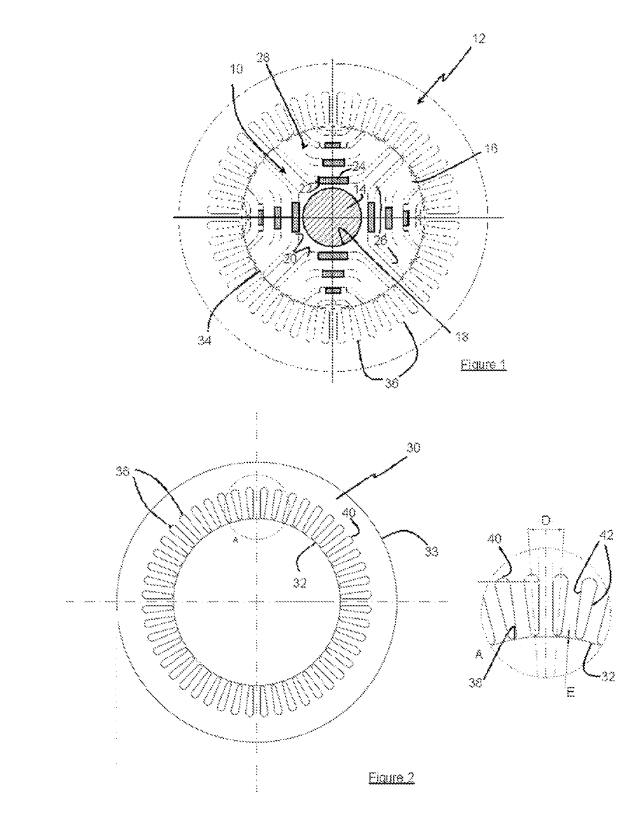

As illustrated in FIG. 1, a rotary electric machine, in this instance a permanent magnet assisted synchronous variable reluctance machine, comprises a rotor 10 and a stator 12 nested one inside the other coaxially.

The rotor, in a way known per se, comprises a shaft 14, preferably magnetic, on which a stack of identical planar ferromagnetic laminations 16 is placed, these being assembled to one another in any known way.

The circular laminations 16 comprise a central bore 18 through which the rotor shaft 14 passes and a plurality of axial recesses 20 which pass right through the laminations.

A first series of rectangular axial recesses 22, arranged radially one outside the other and at a distance from one another, form housings for magnetic-flux generators, in this instance permanent magnets 24 in the form of identical rectangular bars of a length substantially equal to the length of the stack of laminations.

The other series of recesses are perforations 26 of inclined radial direction which start from these housings and extend towards the vicinity of the edge of the laminations.

As has been depicted in FIG. 1, the inclined perforations are arranged symmetrically with respect to the magnet housings 22. Thus a geometric figure is formed in each instance that is substantially in the shape of a V with a flattened bottom with the flat bottom being formed by the housing 22 and with the inclined arms of this V being formed by the perforations 26.

Flux barriers 28 formed by the perforations are thus created. The magnetic flux coming from the magnets can therefore pass only via the solid parts between the perforations.

With reference also to FIG. 2, the stator 12 comprises an annular ring 30 with an internal wall 32 the inside diameter of which is designed to house the rotor 10 with the space necessary to create an air gap 34, and an external wall 33.

This ring comprises a multitude of drillings 36, here of oblong cross section, which form closed slots for the armature windings.

More specifically, these drillings extend axially all along the stator, being arranged radially on the ring and at the same time positioned circumferentially at a distance D apart.

In the example described, these oblong drillings have a bottom wall 38 of semicircular shape which is situated at a distance E from the internal wall 32 of the stator, the top wall 40 likewise of semicircular shape, in this instance with a diametral dimension greater than that of the bottom wall, and at a distance from the external wall 33 of the stator, and two lateral faces 42 connecting the ends of the semicircular walls.

Advantageously, the distance E has a minimum value of 0.35 mm and a maximum value of between 0.5 mm and 1 mm.

In this way, a closed volume is created that forms a closed slot to house the armature winding.

Thus, the wall 32 is a continuous wall and the air gap 34 between the rotor and the stator is near-constant and is so over the entire circumference.

In addition, because the outside of the rotor and the inside of the stator are smooth, that means that the level of aerodynamic noise can be low.

Of course, and without thereby departing from the scope of the invention, these drillings may have some cross section other than an oblong cross section, such as a cylindrical cross section.

In that case, the top and bottom walls of the slots have the same dimetral dimension and form a closed line such as a circle or an oval.

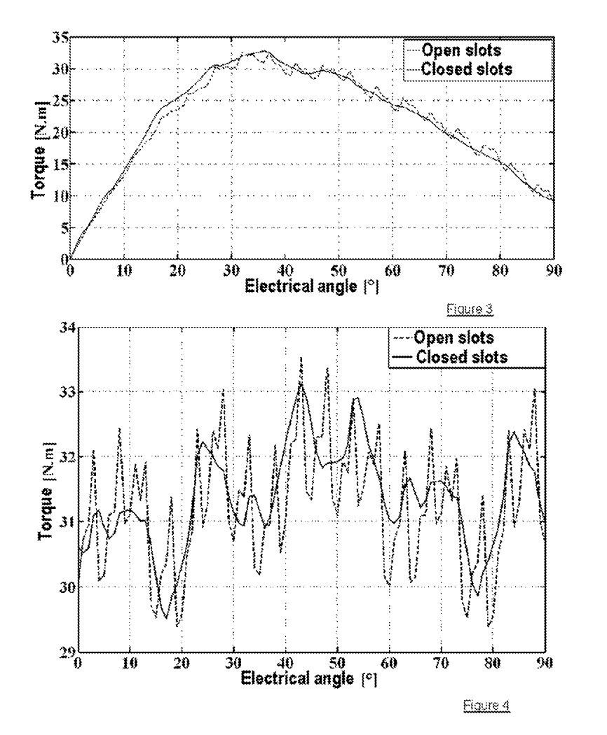

Reference is now made to FIG. 3 which is a graph with curves illustrating the torque of the electrical machine (in N·m) with respect to the electrical position of the rotor (in °) for a constant current, for a machine of the prior art (dotted line) with open slots in the stator and for a machine according to the invention (heavy line) with closed slots for the stator. It may be observed that the variations in torque of the machine, which are essentially due to the effects of the slots, are greatly diminished from a machine according to the invention in comparison with a machine of the prior art.

FIG. 4 is a graph with curves illustrating the instantaneous torque of the electric machine (in N·m) with respect to the electric position of the machine (in °) for a constant current and a constant deflux angle, for a machine with open stator slots (prior art) and for a machine according to the invention with closed stator slots.

In this figure, it may be noted that the variations in (in ripple on) the torque of the electric machine according to the invention are greatly diminished in comparison with an electric machine according to the prior art.

1-5: (canceled)

6. An electric machine having a rotor and a stator comprising:
an internal wall facing the rotor, the stator including radial slots disposed circumferentially around the stator; and wherein the slots comprise a bottom wall separated from the internal wall of the stator to close the radial slots.

7. Electric machine according to claim 6, wherein the slots extend axially along the stator.

8. An electric machine according to claim 6, wherein the slots have an oblong cross section with the bottom wall being separated from the wall of the stator, a top wall and two faces connecting the walls.

9. An electric machine according to claim 7, wherein the slots have an oblong cross section with the bottom wall being separated from the wall of the stator, a top wall and two faces connecting the walls.

10. An electric machine according to claim 6, wherein the slots have a circular cross section.

11. An electric machine according to claim 7, wherein the slots have a circular cross section.

12. An electric machine according to claim 6, wherein the rotor comprises housings containing magnetic-flux generators and recesses providing magnetic flux barriers.
